(19) United States
(12) Patent Application Publication
(10) Pub. No.: US 2026/0039133 A1
(43) Pub. Date: Feb. 5, 2026

(54) POWER SUPPLY SYSTEM AND METHOD FOR AN INDUCTIVE LOAD

(71) Applicant: SAIA-BURGESS LLC, VANDALIA, OH (US)

(72) Inventors: Kenneth S LEVINE, Tipp City, OH (US); Adam STIENECKER, Tipp City, OH (US); Kurtis David KEENER, Gahanna, OH (US)

(21) Appl. No.: 19/352,024

(22) Filed: Oct. 7, 2025

Related U.S. Application Data
(63) Continuation of application No. PCT/US2023/018287, filed on Apr. 12, 2023.

(51) Int. Cl. H02J 7/00; H02J 7/34; H02M 1/00; H02M 3/00; H02M 7/00; H02M 7/5387

(52) U.S. Cl. CPC H02J 7/0063; H02J 7/345; H02M 1/007; H02M 3/003; H02M 7/003; H02M 7/5387; H02J 2207/50

(57) ABSTRACT

A power supply system is provided for energizing a wire coil of an inductive load, such as a solenoid, with a DC power source. A power supply circuit includes an energy storage device, a DC-to-DC boost converter that steps-up voltage from the DC power source to the energy storage device, a charge switch that regulates flow of electric current from the DC power source to the energy storage device, and a discharge switch that regulates flow of electric current from the energy storage device to the wire coil. A processor executes instructions stored on a memory to implement a power supply method that includes controlling the charge switch and discharge switch to sequentially charge the energy storage device using the DC power source, and discharge the energy storage device to energize the wire coil.

### CROSS REFERENCE TO RELATED APPLICATIONS

This non-provisional patent application is a continuation application of PCT Application No. PCT/US2023/018287, filed with the USPTO on Apr. 12, 2023, which is incorporated herein by reference in its entirety.

### FIELD OF THE INVENTION

This disclosure relates to a power supply system and method for energizing a wire coil of an inductive load such as a solenoid.

### BACKGROUND

Solenoids are actuators that convert electrical energy to mechanical energy using a ferromagnetic armature that moves relative to a wire coil used as an electromagnet. Solenoids are used in a variety of applications, such as warehouse control systems, material handling systems, and conveyor belt sorting systems. In such applications, precise and rapid response of the solenoid with short cycle times (e.g., tens of milliseconds) is important.

FIG. 1 shows a prior art power supply circuit 2 that connects a direct current (DC) power source 4 to a solenoid 10 with conductive leads 6. One of the conductive leads 6 includes a switch 8 that can be opened and closed to actuate the solenoid 10. The DC power source 4 may provide a relatively high level of maximum current (e.g. 30 A (amperes)) over a short time interval (e.g. 1.5 to 2 milliseconds), and is typically located remotely from the solenoid 10 such that the conductive leads have substantial lengths. This results in a non-trivial line loss between the DC power source 4 and the wire coil of the solenoid 10, due to resistance as well as reactive inductance associated with rapid operation of the switch 8. This line loss reduces the electrical power supplied to the wire coil of the solenoid 10, which delays the actuation response time of the solenoid 10. The DC power source 4 and conductive leads 6 may be configured to compensate for these phenomena, but this may add expense and compete against desires to limit the voltage and current of the DC power source 4 for cost and safety reasons. Also, the solenoid 10 will not actuate properly in the event of a failure of power input to the solenoid 10.

There is a need in the art for a power supply circuit for a solenoid that addresses these problems.

### SUMMARY OF THE INVENTION

In one aspect, the present disclosure includes a power supply system for energizing a wire coil of an inductive load using a DC power source. The power supply system comprises a power supply circuit that comprises at least one energy storage device, a DC-to-DC boost converter, at least one charge switch, and at least one discharge switch. The DC-to-DC boost converter is configured to step-up voltage from the DC power source to the at least one energy storage device. The at least one charge switch is operable to regulate flow of electric current from the DC power source, via the DC-to-DC boost converter, to the at least one energy storage device. The at least one discharge switch is operable to regulate flow of electric current from the at least one energy storage device to the wire coil.

In embodiments of the power supply system, the at least one energy storage device comprises a capacitor, which may be a supercapacitor. In embodiments of the power supply system, the at least one energy storage device comprises a galvanic cell.

In embodiments of the power supply system, the at least one energy storage device comprises a plurality of energy storage devices in parallel connection or in series connection with each other.

In embodiments of the power supply system, a conductive lead connecting the DC power source to the DC-to-DC boost converter is configured such that, in use, the electric current in the conductive lead is 5 amperes or less.

In embodiments of the power supply system, the at least one energy storage device is connected to the wire coil with a conductive lead having a length of 100 mm or less.

In embodiments of the power supply system, the DC-to-DC boost converter is configured to step-up the voltage from the DC power source to an output voltage of 100 volts or greater.

In embodiments of the power supply system, the system comprises an H-bridge circuit comprising first, second and third legs. The first and second legs are connected in parallel to the at least one energy storage device and each comprise a pair of switches. The third leg comprises the wire coil of the inductive load and connects the first and second legs at nodes between the pairs of switches. The at least one discharge switch comprises at least one of the switches of the H— bridge circuit.

In embodiments of the power supply system, the system comprises a printed circuit board operatively connecting the at least one energy storage device, the DC-to-DC boost converter, the at least one charge switch, and the at least one discharge switch.

In embodiments of the power supply system, the system comprises at least one processor and at least one memory. The at least one processor is operatively connected to the at least one charge switch and the at least one discharge switch. The at least one memory comprises a non-transitory computer readable medium storing instructions executable by the at least one processor to implement a power supply method. The power supply method comprises controlling the at least one charge switch and the at least one discharge switch to configure the power supply circuit sequentially from a charge mode to a discharge mode. In the charge mode: the power supply circuit permits flow of electric current from the DC power source, via the DC-to-DC boost converter, to the at least one energy storage device, thereby charging the at least one energy storage device; and the power supply circuit prevents flow of electric current from the at least one energy storage device to the wire coil. In the discharge mode: the power supply circuit prevents flow of electric current from the DC power source to the at least one energy storage device; and the power supply circuit permits flow of electric current from the at least one energy storage device to the wire coil, thereby energizing the wire coil.

In embodiments of the power supply system, the inductive load comprises a solenoid. The charge mode may be performed to charge the at least one energy storage device with energy sufficient to energize the wire coil for a plurality of actuation movements of an armature of the solenoid. The solenoid may be a bistable solenoid, and the plurality of actuation movements may comprise an actuation cycle that comprises a first actuation of the armature in a forward direction, and a second actuation of the armature in a reverse direction. In other embodiments, the charge mode may be performed to charge the at least one energy storage device with energy sufficient to energize the wire coil for only one actuation movement of an armature of the solenoid. The solenoid may be a bistable solenoid, and the one actuation movement may comprise either a forward actuation or a reverse actuation of the armature.

In another aspect, the present disclosure includes power supply method for energizing a wire coil of an inductive load using a DC power source. The power supply method comprises: using a processor to control at least one charge switch and at least one discharge switch to configure a power supply circuit sequentially from a charge mode to a discharge mode. In the charge mode: the power supply circuit permits flow of electric current from the DC power source, via a DC-to-DC boost converter configured to step-up voltage, to at least one energy storage device, thereby charging the at least one energy storage device; and the power supply circuit prevents flow of electric current from the at least one energy storage device to the wire coil. In the discharge mode: the power supply circuit prevents flow of electric current from the DC power source to the at least one energy storage device; and the power supply circuit permits flow of electric current from the at least one energy storage device to the wire coil, thereby energizing the wire coil.

In embodiments of the power supply method, the at least one energy storage device comprises a capacitor, and may be a supercapacitor. In embodiments of the power supply method, the at least one energy storage device comprises a galvanic cell.

In embodiments of the power supply method, during the charge mode, an electric current in a conductive lead connecting the DC power source to the DC-to-DC boost converter is 5 amperes or less.

In embodiments of the power supply method, the at least one energy storage device is connected to the wire coil with a conductive lead having a length of 100 mm or less.

In embodiments of the power supply method, the inductive load comprises a solenoid. The charge mode may be performed to charge the at least one energy storage device with energy sufficient to energize the wire coil for a plurality of actuation movements of an armature of the solenoid. The solenoid may be a bistable solenoid, and the plurality of actuation movements may comprise an actuation cycle that comprises a first actuation of the armature in a forward direction, and a second actuation of the armature in a reverse direction. In other embodiments, the charge mode may be performed to charge the at least one energy storage device with energy sufficient to energize the wire coil for only one actuation movement of an armature of the solenoid. The solenoid may be a bistable solenoid, and the one actuation movement may comprise either a forward actuation or a reverse actuation of the armature.

### BRIEF DESCRIPTION OF THE DRAWINGS

The foregoing and other aspects of the disclosure will be better appreciated with reference to the attached drawings, as follows.

FIG. 1 shows a schematic depiction of a prior art power supply circuit for a solenoid.

FIG. 2 shows a schematic depiction of a prior art solenoid to which the power supply system of the present disclosure may be applied.

FIG. 3A shows a perspective view of an embodiment of a prior art rotary solenoid to which the power supply system of the present disclosure may be applied.

FIG. 3B shows a perspective view of an embodiment of the rotor assembly of the prior art rotary solenoid of FIG. 3A.

FIG. 4 shows a functional block diagram of an embodiment of a power supply system of the present disclosure operatively connected to a DC power source and a solenoid.

FIG. 5 shows an embodiment of a printed circuit board including at least part of a power supply system of the present disclosure, when the part of the power supply system is removed from a housing of a solenoid.

FIG. 6 shows a schematic depiction of an embodiment of a power supply circuit of the present disclosure connected to a DC power source and a wire coil of a solenoid.

FIG. 7 shows a table relating switch configurations in the power supply circuit of FIG. 6 to produce different power supply modes.

FIG. 8 shows a flow chart of an embodiment of a power supply method of the present disclosure.

### DETAILED DESCRIPTION OF THE PREFERRED EMBODIMENTS

### Interpretation.

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used in this document, “attached” in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, microcontroller units (MCU), central processing units (CPU), digital signal processors, and field programmable gate arrays (FPGAs).

Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments of the disclosures described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

### Inductive Load and Solenoid.

The present disclosure relates to a power supply circuit for energizing a wire coil of an inductive load. “Inductive load” as used herein refers to an electrically powered device having a wire coil, which when energized by electric current, produces a magnetic field that interacts with a ferromagnetic member of the device. Non-limiting examples of an inductive load include a solenoid, a motor, an electromagnet, a transformer, and an inductor.

“Solenoid” as used herein refers to an actuator that converts electrical energy to mechanical energy using a ferromagnetic armature (e.g., a plunger or a rotor) that moves (e.g., slides within or rotates) relative to a wire coil used as an electromagnet. A solenoid may be a linear solenoid having an armature in the form of a sliding plunger, or a rotary solenoid that converts the sliding motion of the armature in the form of a plunger to rotational movement of another part of the solenoid, or a rotary solenoid having an armature in the form of a rotating rotor. Solenoids and their principle of operation are well known and do not by themselves constitute part of the present invention.

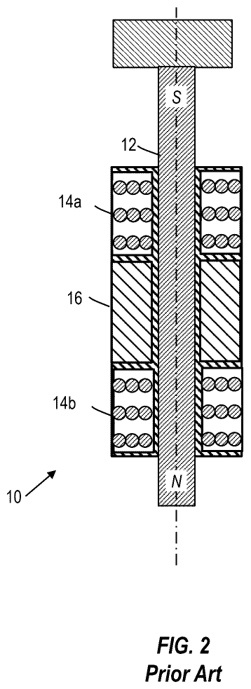

For completeness, FIG. 2 shows a schematic depiction of an exemplary solenoid 10, which in this case is a bistable solenoid including an armature 12 that slides within and relative to a first wire coil 14a and a second wire coil 14b (either being a wire coil 14), and a permanent magnet 16, to actuate a load. Electric current flowing through the wire coil 14 in one direction (e.g., a positive current) induces a polarized magnetic field that acts upon the armature 12 to actuate translational motion of the armature 12 relative to the wire coil 14 in a first actuation direction (e.g., toward the top of the drawing plane of FIG. 2). The permanent magnet 16 has a permanent magnetic field that is used to “hold” or “latch” the armature 12 in this energized position, although the permanent magnetic field by itself is not sufficient to actuate the armature to the energized position. The direction of current flow through the wire coil 14 may be reversed (e.g., a negative current) to induce an oppositely polarized magnetic field to accelerate motion of the armature 12 relative to the wire coil 14 in a second direction opposite to the first actuation direction (e.g., toward the bottom of the drawing plane of FIG. 2). The foregoing description of the operation of the wire coil 14 is applicable to both the first and second wire coils 14a and 14b, such that the armature can be actuated to opposite energized positions from a neutral position. In embodiments, the solenoid 10 may have other parts (not shown) such as springs that bias the armature 12 to an initial or neutral position, and in the case of a rotary solenoid, parts that translate linear motion of the armature 12 to rotary motion of another part such as bearings and inclined raceways.

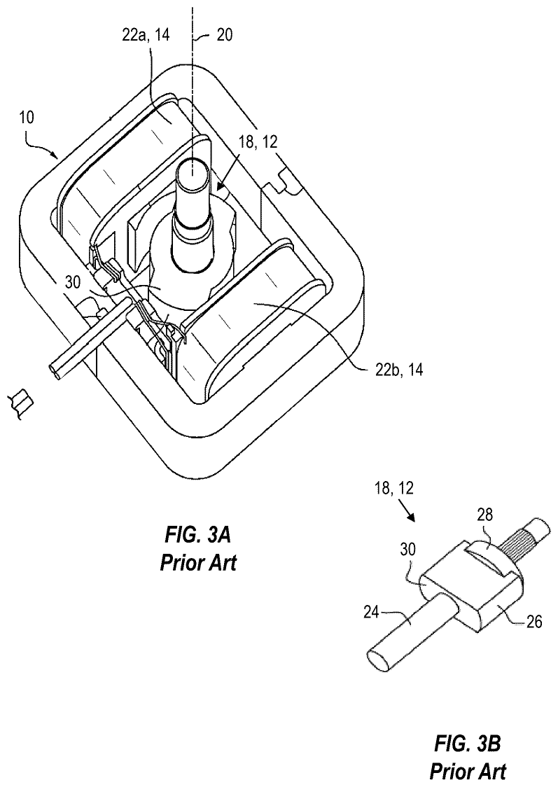

FIG. 3A shows a rotary solenoid 10 in the prior art to which the control system and control method of the present disclosure may also be applied. The rotary solenoid 10 is described and shown in U.S. Pat. No. 9,257,888 (Feb. 9, 2016; Gruden; Johnson Electric S.A.). The solenoid 10 includes an armature 12 in the form of a rotor assembly 18 that rotates about rotor axis 20, and a wire coil 14 in the form of electrically connected half wire coils 22a and 22b. FIG. 3B shows the rotor assembly 18 of the rotary solenoid 10 of FIG. 3A. The rotor assembly 18 includes a shaft 24 with an attached permanent magnet 26 that rotates with the shaft 24, and is used to latch the rotor assembly 18 in one or more positions. In this embodiment, the permanent magnet 26 is mounted to a shaft 24 by a retainer 28. In other embodiments, the permanent magnet 26 may be attached to the shaft 24 by other means, such as by fasteners or adhesives, being over-molded on to the shaft 24, or formed integrally with the shaft 24, in such a way that the permanent magnet 26 rotates with the shaft 24. The permanent magnet 26 has a pair of enlarged rotor lobes 30 that are oriented at 180 degrees angles with respect to each other.

### Power Supply System.

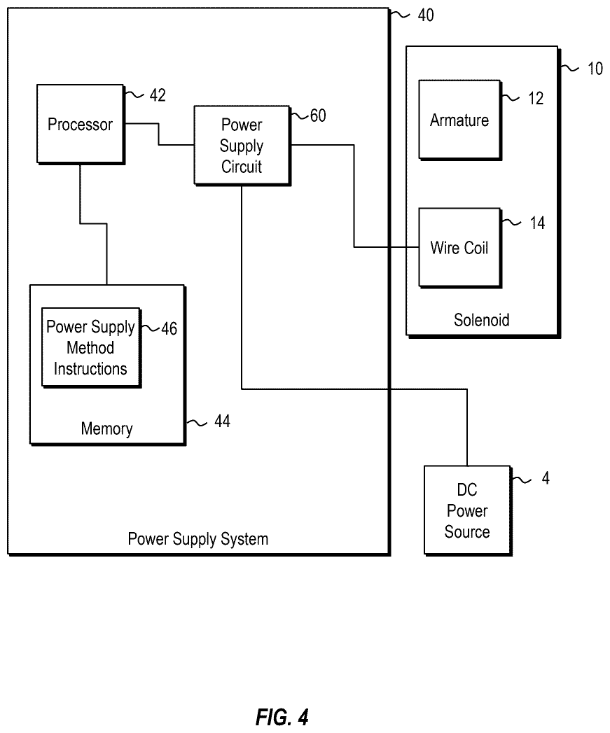

FIG. 4 shows a functional block diagram of an embodiment of a power supply system 40 of the present disclosure operatively connecting a direct current (DC) power source 4 to the wire coil 14 of a solenoid 10.

Although FIG. 4 shows the inductive load in the form of a solenoid 10, the power supply system 40 may be applied to other types of inductive loads such as a motor or an electromagnet.

The DC power source 4 may be any DC power source. As a non-limiting example, the DC power source 4 may be a DC output of programmable logic controller (PLC), which coverts an alternating current (AC) input line voltage to a lower DC output voltage (e.g., 24 volts or less).

The power supply system 40 includes at least one processor 42, at least one memory 44 and a power supply circuit 60. These components are operatively connected to each other, as shown by the connecting lines therebetween in FIG. 4. Although FIG. 4 shows the at least one processor 42 and the at least one memory 44 by single blocks, each of these components may include a plurality of components or sub-components that are operatively connected to each other.

The processor 42 is operatively connected to the power supply circuit 60 to control switches thereof, in accordance with power supply modes, as described below. For example, the processor 42 may be connected via a driver circuit to the switches of the power supply circuit 60. The memory 44 stores power supply method instructions 46 that are executable by the processor 42 to implement a power supply method as described below. The memory 44 may be considered as a computer-program product of the present disclosure. The power supply circuit 60 operatively connects the DC power source 4 to the wire coil 14 of the solenoid 10, as further described below.

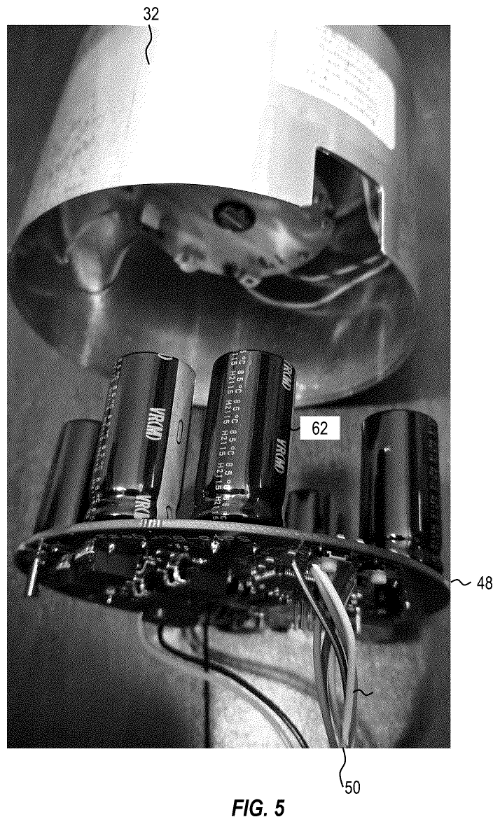

In one embodiment, such as shown in FIG. 5, the power supply circuit 60, and optionally, the processor 42 and the memory 44, may be operatively connected by a printed circuit board (PCB) 48, which may be received within the housing 32 of the solenoid 10 or another inductive load. For example, the processor 42 may be implemented by a microcontroller unit, the memory 44 may be implemented by associated firmware, and at least some of the components of the power supply circuit 60 may be implemented with electronic devices such as solid-state semiconductor devices. The printed circuit board 48 may be operatively connected to DC power source 4 and to the wire coil 14 with wire connector bus 50.

In other embodiments, either one or both of the processor 42 or the memory 44 may be wholly or partly implemented by devices that are physically discrete and remote from the power supply circuit 60. For example, a processor and storage media of a server or computer workstation may be operatively connected to the power supply circuit 60 (e.g., by wire or wireless connections, and/or a communications network such as an intranet or the Internet) in accordance with distributed computing techniques known in the art.

### Power Supply Circuit.

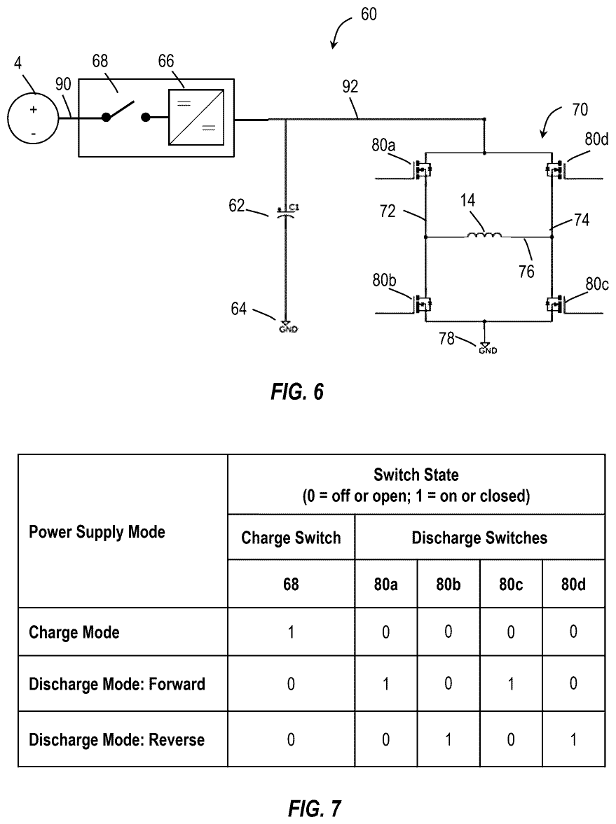

FIG. 6 shows a schematic depiction of an embodiment of a power supply circuit 60 of the present disclosure connected a DC power source 4 and a wire coil 14 of an inductive load such as a solenoid 10 as shown in FIG. 2 or FIGS. 3A and 3B. The power supply circuit 60 includes at least one energy storage device 62, a direct current-to-direct current (DC-to-DC) boost converter 66, at least one charge switch 68 and at least one discharge switch 80. Although FIG. 6 shows certain components of the power supply circuit 60 symbolically as a single component, it will be understood that each component may include a plurality of components or sub-components that are operatively connected to each other. Although FIG. 6 shows the charge switch 68 as symbolically discrete from the DC-to-DC boost converter 66, the charge switch 68 may be implemented by a switch of the DC-to-DC boost converter 66 when the latter is implemented by switching techniques as is known in the art.

The at least one energy storage device 62 is used to store energy from the DC power source. The at least one energy storage device 62 may include a plurality of energy storage devices 62 in parallel connection or in series connection with each other.

In the embodiment shown in FIG. 6, the energy storage device 62 comprises a capacitor—i.e., a device that stores energy electrostatically—connected to an electrical ground 64. Capacitors are known in the art and do not by itself form part of the present invention. In the embodiment shown FIG. 5 as a non-limiting example, the power supply circuit 60 includes eight aluminum electrolytic capacitors. Other embodiments may have a different number of capacitors and I or types of capacitors. In embodiments, the capacitor may be a supercapacitor, which is known in the art and does not by itself form part of the present invention. In contrast to capacitors that use a solid dielectric to separate the conductive plates, the conductive plates of a supercapacitor are soaked in an electrolyte and separated by a thin insulative, ion-permeable membrane separator. Supercapacitors may allow for higher capacitance values than other types of capacitors. In embodiments, the energy storage device may comprise a galvanic cell that stores energy electrochemically.

The DC-to-DC boost converter 66 is used to step-up (i.e. increase) voltage from the DC power source 4 to the at least one energy storage device 62. In embodiments, the DC-to-DC boost converter 66 may be implemented with a solid-state semiconductor device. DC-to-DC converters may be implemented in a variety of ways, as known in the art. As a non-limiting example, the DC-to-DC converter may a charge pump with one or more capacitors, as known in the art.

The at least one charge switch 68 is operable to regulate flow of electric current from the DC power source 4 to the energy storage device 62 via the DC-to-DC boost converter 66. The term “charge” in the expression charge switch 68 is used as an identifier because of the use of the charge switch 68 in implementing the charge mode of the power supply circuit 60 in which the DC power source 4 charges the energy storage device 62, as described below.

In embodiments in which the energy storage device 62 comprises a galvanic cell, the power supply circuit 60 between the DC power source 4 and the galvanic cell may further include circuit component(s) (e.g. electric current sensor(s), temperature sensor(s), switch(es), and I or processor(s)) to regulate the flow of electric current from the DC power source 4 to the galvanic cell. Such circuit component(s) may be used to further regulate the charge mode to prevent undesirable phenomenon such as overheating, degradation or damage to the galvanic cell.

The at least one discharge switch 80 is operable to regulate flow of electric current from the energy storage device 62 to the wire coil 14 of the inductive load. The term “discharge” in the expression discharge switch 80 is used as an identifier because of the use of the discharge switch 80 in implementing the discharge mode of the power supply circuit 60 in which the energy storage device 62 discharges electric current to the wire coil 14 of the inductive load and thereby energizes the wire coil 14, as described below.

In embodiments, the at least one discharge switch 80 may be implemented by one or a plurality of switches. In the embodiment of FIG. 6, the plurality of discharge switches is implemented by switches 80a, 80b, 80c, and 80d of an H-bridge circuit 70. The H-bridge circuit topology, by itself, is known in the art. In relation to the energy storage device 62, the H-bridge circuit 70 has two parallel legs 72, 74, each having a pair of switches—i.e., switches 80a and 80b with respect to the first parallel leg 72, and switches 80c and 80d with respect to the second parallel leg 74. The H-bridge circuit 70 also has a third connecting leg 76 that connects the two legs at nodes between their respective switches 80a, 80b and 80c, 80d. The third connecting leg 76 includes the wire coil 14 of the inductive load. In one embodiment, the H-bridge circuit 70 is implemented by an integrated circuit and the switches 80a, 80b, 80c, 80d are metal oxide semiconductor field effect transistors (MOSFETs) to permit high speed switching. In other embodiments, the switches 80a, 80b, 80c, 80d may be implemented by other types of electromechanically components. The H-bridge circuit 70 is connected to an electrical ground 78.

In embodiments, the conductive lead 90 connecting the DC power source 4 to the DC-to-DC boost converter 66 is configured so that, in use during the charge mode as discussed below, the electric current in the conductive lead 90 is 5 amperes or less. It will be within the skill of a person of ordinary skill in the art to achieve this effect by selecting properties of the conductive lead such as its material and cross-sectional area, having regard to the electrical output characteristics of the DC power source 4. Limiting the magnitude of electric current in the conductive lead 90 helps to limit the line loss in the conductive lead 90, recognizing that line loss is theoretically proportional to the square of the magnitude of electric current.

In embodiments, the conductive lead 92 connecting the energy storage device 62 to the wire coil 14 of the solenoid 10 has a length of 100 mm or less. Limiting the length of the conductive lead 92 helps to limit line loss in the conductive lead 92, recognizing that line loss is theoretically proportional to the length of the conductive lead 92. As previously described with reference to the embodiment shown in FIG. 5, this relatively short length of conductive lead 92 may be possible by implementing the power supply circuit 60 on a PCB 48 in close proximity to the solenoid 10.

### Power Supply Modes.

FIG. 7 shows a table relating configurations of the charge switch 68 and the discharge switch 80a, 80b, 80c, 80d of the power supply circuit 60 of FIG. 6 to configure the power supply circuit 60 in a charge mode and a discharge mode. In FIG. 7, the digit “0” denotes that a switch is in the “open” or “off” state, in which electric current cannot flow through the switch; the digit “1” denotes that a switch is in the “closed” or “on” state, in which electric current can flow through the switch. FIG. 7 defines one charge mode and two discharge modes, denoted forward and reverse, for actuating the armature 12 of a bistable solenoid 10, such as shown in FIG. 2, in a forward direction and a reverse direction, respectively.

In the charge mode, the charge switch 68 is in the closed/on state. Accordingly, the power supply circuit 60 permits flow of electric current from the DC power source 4, via the DC-to-DC boost converter 66 to the energy storage device 62, thereby charging the energy storage device 62. At the same time, all of the discharge switches 80a, 80b, 80c, 80d are in the open/off state. Accordingly, the power supply circuit prevents flow of electric current from the energy storage device 62 to the wire coil 14.

In each of the discharge modes, the charge switch 68 is in the open/off state. Accordingly, the power supply circuit 60 prevents flow of electric current from the DC power source 4, via the DC-to-DC boost converter 66, to the energy storage device 62.

In the forward discharge mode, the discharge switches 80a, 80c, are in the closed/on state, while the discharge switches 80b, 80d are in the open/off state. Accordingly, the power circuit permits flow of electric current from the energy storage device 62 through the wire coil 14 in a forward direction (e.g., left to right in the drawing plane of FIG. 6) so that a magnetic field is induced in the wire coil 14 to actuate the armature 12 in the forward direction (e.g., toward the top of the drawing plane of FIG. 2).

In the reverse discharge mode, the discharge switches 80b, 80d, are in the closed/on state, while the discharge switches 80a, 80c are in the open/off state. Accordingly, the power circuit permits flow of electric current from the energy storage device 62 through the wire coil 14 in a reverse direction (e.g., right to left in the drawing plane of FIG. 6) so that a magnetic field is induced in the wire coil 14 to actuate the armature 12 in the reverse direction (e.g., toward the bottom of the drawing plane of FIG. 2).

### Power Supply Method.

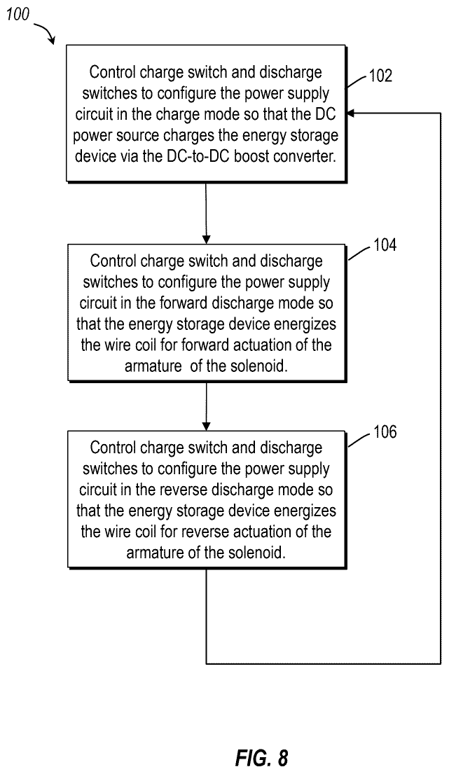

FIG. 8 is a flow chart of an embodiment of a power supply method 100 of the present disclosure for energizing the wire coil 14 of an inductive load, in the form of a bistable solenoid 10 such as shown in FIG. 2. The steps of the power supply method 100 are performed by the processor 42 executing the power supply method instructions 46 stored by the memory 44, as shown in FIG. 4. This embodiment of the power supply method 100 may be implemented using the power supply circuit 60 having an H-bridge circuit 70 as shown in FIG. 6, with the processor 42 capable of controlling the charge switch 68 and the discharge switches 80a, 80b, 80c, 80d to configure the power supply circuit 60 in the charge mode and discharge modes as shown in FIG. 7.

At step 102, the processor 42 controls the charge switch 68 and the discharge switches 80a, 80b, 80c, 80d to configure the power supply circuit in the charge mode of FIG. 7. Accordingly, the DC power source 4 charges the energy storage device 62 via the DC-to-DC boost converter 66.

At step 104, the processor 42 controls the charge switch 68 and the discharge switches 80a, 80b, 80c, 80d to configure the power supply circuit in the forward discharge mode of FIG. 7. Accordingly, the energy storage device 62 energizes the wire coil 14 for forward actuation of the armature 12 of the solenoid 10.

At step 106, the processor 42 controls the charge switch 68 and the discharge switches 80a, 80b, 80c, 80d to configure the power supply circuit in the charge mode of FIG. 7. Accordingly, the DC power source 4 again charges the energy storage device 62 via the DC-to-DC boost converter 66.

At step 108, the processor 42 controls the charge switch 68 and the discharge switches 80a, 80b, 80c, 80d to configure the power supply circuit in the reverse discharge mode of FIG. 7. Accordingly, the energy storage device 62 energizes the wire coil 14 for reverse actuation of the armature 12 of the solenoid 10.

After step 108, the power control method 100 may return to step 102 and repeat steps 102 to 106 for subsequent actuation cycles of the solenoid.

The embodiment of the power control method 100 as shown in FIG. 8 may be varied. For example, the power control method 100 may be adapted for a monostable solenoid 10. In this case, the power supply circuit 60 may be configurable in the forward discharge mode, but not the reverse discharge mode. Accordingly, steps 106 and 108 may be omitted from the power control method 100, and the method would return to step 102 after completing step 104 for one or more times.

The duration of the charge mode may be controlled to determine the degree to which the energy storage device 62 is charged. In one embodiment, the duration of the charge mode may be controlled so that the energy storage device 62 may be charged to allow for multiple actuation movements of the armature 12 of a solenoid 10 during the discharge mode, before returning to the charge mode. For example, in the case of a bistable solenoid, the energy storage device 62 may be charged to allow for one or more actuation cycles of the solenoid, with each actuation cycle including a forward actuation followed by a reverse actuation, as described above. For example, the method of FIG. 8 may be modified to perform steps 102 and 104, and then perform step 108 without performing step 106. As another example, FIG. 8 may be modified to perform step 102 and then perform steps 104 and 108 (without performing step 106) for multiple times before performing step 102 again. Also, in this manner, the energy storage device 62 can serve as a power reserve to allow for continued operation of the solenoid 10 during a temporary failure of the DC power source 4.

In another embodiment, the duration of the charge mode may be controlled so that the energy storage device 62 may be charged to allow for only one actuation movement of the armature 12 of a solenoid 10; the actual movement may be only a forward actuation as described above, or only a reverse actuation as described above. For example, as shown in FIG. 8 for the case of a bistable solenoid, it may be necessary to charge the energy storage device 62 by performing step 102 before each forward actuation of the armature 12 performed in step 104, and by performing step 106 before each reverse actuation of the armature 12 performed in step 108. Limiting the charge mode in this manner may advantageously allow for more consistent output voltage from the energy storage device 62 to the wire coil 14. In turn, this may allow for greater consistency in the actuation performance of the solenoid 10, which may be important in applications such as sortation systems.

### Potential Advantages.

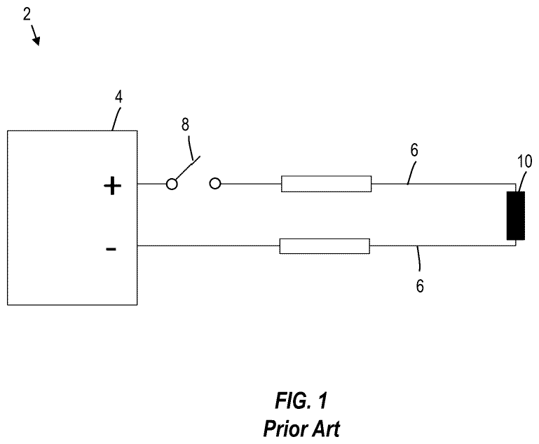

In comparison with the prior art power supply circuit shown in FIG. 1, the power supply system 40 and the power supply method 100 may be advantageous in one or more respects.

The use of the DC-to-DC boost converter 66 may allow the DC power source 4 to be configured for a lower voltage and current than would otherwise be required to acuate a solenoid 10 with certain performance parameters. Thus, the DC power source 4 may be more economical, and may more readily satisfy safety or regulatory requirement requirements. This may also allow use of more economical, lower gauge conductive leads between the DC power source 4 and the power supply circuit 60.

As described above, the conductive lead 90 connecting the DC power source 4 to the DC-to-DC boost converter 66 may be configured so that, during the charge mode, the electric current in the conductive lead 90 is relatively low (e.g. 5 amperes or less). At the same time, the conductive lead 92 connecting the energy storage device 62 to the wire coil 14 of the solenoid 10 may have a length of 100 mm or less. These features may allow for a lower total line loss, for a given distance between the DC power source 4 and the wire coil 14.

As described above, the charge mode may be performed to charge the energy storage device 62 with reserve energy for energizing the wire coil 14 multiple times, so that the wire coil 14 can still be energized during a temporary power outage of the DC power source 4 (e.g., to induce multiple actuation movement(s) of an armature 12 of a solenoid 10). Alternatively, the charge mode may be performed to charge the energy storage device 62 with energy sufficient for energizing the wire coil 14 only one time (e.g., to induce only one actuation moment of an armature 12 of a solenoid 10), which may help with consistent control over the performance characteristics of the inductive load.

While the description contained herein constitutes a plurality of embodiments of the present disclosure, it will be appreciated that the present disclosure is susceptible to further modification and change without departing from the fair meaning of the accompanying claims.

### PART LIST

2 prior art power supply circuit
4 prior art power circuit, DC power source
6 prior art power circuit, conductive lead
8 prior art power circuit, switch
10 solenoid
12 solenoid, armature
14 solenoid, wire coil
16 solenoid, permanent magnet
18 Solenoid, rotor assembly
20 Solenoid, rotor axis
22a, b Solenoid, wire coil, half wire coils
24 Solenoid, rotor assembly, shaft
26 Solenoid, rotor assembly, permanent magnet
28 Solenoid, rotor assembly, retainer
30 Solenoid, rotor, assembly, permanent magnet, lobe
32 Solenoid, housing
40 power supply system
42 power supply system, processor
44 power supply system, memory
46 power supply system, memory, power supply instructions
48 power supply system, printed circuit board
50 power supply system, wire connector bus
60 power supply circuit
62 power supply circuit, energy storage device (capacitor or galvanic cell)
64 power supply circuit, electrical ground
66 power supply circuit, DC-to-DC boost converter
68 power supply circuit, charge switch
70 H-bridge circuit
72 H-bridge circuit, leg, first parallel
74 H-bridge circuit, leg, second parallel
76 H-bridge circuit, leg, third connecting
78 H-bridge circuit, electrical ground
80a H-bridge circuit, switch, first in first parallel leg/discharge switch
80b H-bridge circuit, switch, second in first parallel leg/discharge switch
80c H-bridge circuit, switch, first in second parallel leg/discharge switch
80d H-bridge circuit, switch, second in second parallel leg/discharge switch
90 conductive lead connecting the DC power source to DC-to-DC boost converter
92 conductive lead connecting the energy storage device to wire coil
100-106 Power supply method and steps thereof

1. A power supply system for energizing a wire coil of an inductive load using a DC power source, the power supply system comprising:
a power supply circuit comprising:
at least one energy storage device;
a DC-to-DC boost converter configured to step-up voltage from the DC power source to the at least one energy storage device;
at least one charge switch operable to regulate flow of electric current from the DC power source, via the DC-to-DC boost converter, to the at least one energy storage device; and
at least one discharge switch operable to regulate flow of electric current from the at least one energy storage device to the wire coil;
wherein the power supply system further comprises an H— bridge circuit comprising:
first and second legs connected in parallel to the at least one energy storage device and each comprising a pair of switches; and
a third leg comprising the wire coil of the inductive load and connecting the first and second legs at nodes between the pairs of switches;
wherein the at least one discharge switch comprises at least one of the switches of the H-bridge circuit.

2. The power supply system of claim 1, wherein the at least one energy storage device comprises a capacitor.

3. The power supply system of claim 2, wherein the capacitor comprises a supercapacitor.

4. The power supply system of claim 1, wherein the at least one energy storage device comprises a galvanic cell.

5. The power supply system of claim 1, wherein the at least one energy storage device comprises a plurality of energy storage devices in parallel connection or in series connection with each other.

6. The power supply system of claim 1, wherein a conductive lead connecting the DC power source to the DC-to-DC boost converter is configured such that, in use, the electric current in the conductive lead is 5 amperes or less.

7. The power supply system of claim 1, wherein the at least one energy storage device is connected to the wire coil with a conductive lead having a length of 100 mm or less.

8. The power supply system of claim 1, wherein the DC-to-DC boost converter is configured to step-up the voltage from the DC power source to an output voltage of 100 volts or greater.

9. The power supply system of claim 1, comprising a printed circuit board operatively connecting the at least one energy storage device, the DC-to-DC boost converter, the at least one charge switch, and the at least one discharge switch.

10. The power supply system of claim 1, comprising:
at least one processor operatively connected to the at least one charge switch and the at least one discharge switch;
at least one memory comprising a non-transitory computer readable medium storing instructions executable by the at least one processor to implement a power supply method comprising controlling the at least one charge switch and the at least one discharge switch to configure the power supply circuit sequentially from a charge mode to a discharge mode, wherein:
in the charge mode:
the power supply circuit permits flow of electric current from the DC power source, via the DC-to-DC boost converter, to the at least one energy storage device, thereby charging the at least one energy storage device; and
the power supply circuit prevents flow of electric current from the at least one energy storage device to the wire coil; and
in the discharge mode:
the power supply circuit prevents flow of electric current from the DC power source to the at least one energy storage device; and
the power supply circuit permits flow of electric current from the at least one energy storage device to the wire coil, thereby energizing the wire coil.

11. The power supply system of claim 10, wherein the inductive load comprises a solenoid, and wherein the charge mode is performed to charge the at least one energy storage device with energy sufficient to energize the wire coil for a plurality of actuation movements of an armature of the solenoid.

12. The power supply system of claim 11, wherein the solenoid is a bistable solenoid, and wherein the plurality of actuation movements comprises an actuation cycle that comprises a first actuation of the armature in a forward direction, and a second actuation of the armature in a reverse direction.

13. The power supply system of claim 10, wherein the inductive load comprises a solenoid, and wherein the charge mode is performed to charge the at least one energy storage device with energy sufficient to energize the wire coil for only one actuation movement of an armature of the solenoid.

14. A power supply method for energizing a wire coil of an inductive load using a DC power source, the power supply method comprising:
using a processor to control at least one charge switch and at least one discharge switch to configure a power supply circuit sequentially from a charge mode to a discharge mode, wherein:
in the charge mode:
the power supply circuit permits flow of electric current from the DC power source, via a DC-to-DC boost converter configured to step-up voltage, to at least one energy storage device, thereby charging the at least one energy storage device; and
the power supply circuit prevents flow of electric current from the at least one energy storage device to the wire coil; and
in the discharge mode:
the power supply circuit prevents flow of electric current from the DC power source to the at least one energy storage device; and
the power supply circuit permits flow of electric current from the at least one energy storage device to the wire coil, thereby energizing the wire coil.

15. The power supply method of claim 14, wherein the at least one energy storage device comprises a capacitor.

16. The power supply method of claim 15, wherein the capacitor comprises a supercapacitor.

17. The power supply method of claim 14, wherein the at least one energy storage device comprises a galvanic cell.

18. The power supply method of claim 14, wherein, during the charge mode, an electric current in a conductive lead connecting the DC power source to the DC-to-DC boost converter is 5 amperes or less.

19. The power supply method of claim 14, wherein the at least one energy storage device is connected to the wire coil with a conductive lead having a length of 100 mm or less.

20. The power supply method of claim 14, wherein the inductive load comprises a solenoid, and wherein the charge mode is performed to charge the at least one energy storage device with energy sufficient to energize the wire coil for a plurality of actuation movements of an armature of the solenoid.

21. The power supply method of claim 20, wherein the solenoid is a bistable solenoid, and wherein the plurality of actuation movements comprises an actuation cycle that comprises a first actuation of the armature in a forward direction, and a second actuation of the armature in a reverse direction.

22. The power supply method of claim 14, wherein the inductive load comprises a solenoid, and wherein the charge mode is performed to charge the at least one energy storage device with energy sufficient to energize the wire coil for only one actuation movement of an armature of the solenoid.
